(19) United States
(12) Patent Application Publication
(10) Pub. No.: US 2026/0197344 A1
(43) Pub. Date: Jul. 9, 2026

(54) System, Method, Computer Program Product for Use of Machine Learning Framework in Adversarial Attack Detection

(71) Applicant: Visa International Service Association, San Francisco, CA (US)

(72) Inventors: Runxin He, Cedar Park, TX (US); Subir Roy, Austin, TX (US); Yu Gu, Austin, TX (US)

(21) Appl. No.: 19/130,168

(22) PCT Filed: Nov. 16, 2022
(86) PCT No.: PCT/US22/50043

§ 371 Date: May 15, 2025

(51) Int. Cl. H04L 9/40; G06N 3/0455; G06N 3/08

(52) U.S. Cl. CPC H04L 63/1466; G06N 3/0455; G06N 3/08

(57) ABSTRACT

Provided is a system that includes a processor to provide a first input to an autoencoder machine learning model; generate a first output of the autoencoder machine learning model based on the first input; provide the first input to a production machine learning model; provide the first output of the autoencoder machine learning model as a second input to the production machine learning model; generate a first output of the production machine learning model based on the first input; generate a second output of the production machine learning model based on the second input; determine a metric of divergence between the first output and the second output of the production machine learning model, wherein the metric of divergence comprises an indication of whether the first input is associated with an adversarial attack; and perform an action. Methods and computer program products are also provided.

### CROSS REFERENCE TO RELATED APPLICATION

This application is the United States national phase of International Application No. PCT/US22/50043 filed Nov. 16, 2022, the disclosure of which is hereby incorporated by reference in its entirety.

### BACKGROUND

### 1. Technical Field

The present disclosure relates generally to detection of adversarial examples and, in some non-limiting embodiments or aspects, to systems, methods, and computer program products for detecting adversarial attacks using a machine learning framework.

### 2. Technical Considerations

Deep neural networks (DNNs) may be used for classification/prediction tasks in a variety of applications, such as facial recognition, fraud detection, disease diagnosis, navigation of self-driving cars, and/or the like. In such applications, DNNs receive an input and generate predictions based on the input, for example, the identity of an individual, whether a payment transaction is fraudulent or not fraudulent, whether a disease is associated with one or more genetic markers, whether an object in a field of view of a self-driving car is in the self-driving car's path, and/or the like.

However, it may be possible for an adversary to craft malicious inputs to manipulate a DNN's prediction. For example, the adversary may generate a malicious input by adding a small perturbation to a sample input that is imperceptible to a human. The changes can result in an input that, when provided to a machine learning model, causes the machine learning model to make a prediction that is different from a prediction that would have been made by the machine learning model based on an input that does not include the malicious perturbations. This type of input is referred to as an adversarial example.

As a result, a machine learning model may generate incorrect predictions based on receiving such adversarial examples as inputs. Although certain techniques have been developed to detect adversarial example s, these techniques may use a number of non-adversarial (e.g., as a reference) and/or adversarial examples to determine whether an input is an adversarial example. As such, these techniques may require systems implementing the techniques to reserve additional computational resources and store enough samples of adversarial and/or non-adversarial examples to determine whether an input is an adversarial example. Furthermore, these techniques may require a lot of time to develop a system that accurately detects adversarial examples as attacks.

### SUMMARY

Accordingly, provided are improved systems, devices, products, apparatus, and/or methods for detecting adversarial attacks using a machine learning framework.

According to some non-limiting embodiments or aspects, provided is a system, comprising: at least one processor programmed or configured to: provide a first input to an autoencoder machine learning model; generate a first output of the autoencoder machine learning model based on the first input; provide the first input to a production machine learning model; provide the first output of the autoencoder machine learning model as a second input to the production machine learning model; generate a first output of the production machine learning model based on the first input; generate a second output of the production machine learning model based on the second input; determine a metric of divergence between the first output of the production machine learning model and the second output of the production machine learning model, wherein the metric of divergence comprises an indication of whether the first input is associated with an adversarial attack; and perform an action based on the metric of divergence.

According to some non-limiting embodiments or aspects, provided is a computer-implemented method, comprising: providing, with at least one processor, a first input to an autoencoder machine learning model; generating, with at least one processor, a first output of the autoencoder machine learning model based on the first input; providing, with at least one processor, the first input to a production machine learning model; providing, with at least one processor, the first output of the autoencoder machine learning model as a second input to the production machine learning model; generating, with at least one processor, a first output of the production machine learning model based on the first input; generating, with at least one processor, a second output of the production machine learning model based on the second input; determining, with at least one processor, a metric of divergence between the first output of the production machine learning model and the second output of the production machine learning model, wherein the metric of divergence comprises an indication of whether the first input is associated with an adversarial attack; and performing, with at least one processor, an action based on the metric of divergence.

According to some non-limiting embodiments or aspects, provided is a computer program product comprising at least one non-transitory computer-readable medium including one or more instructions that, when executed by at least one processor, cause the at least one processor to: provide a first input to an autoencoder machine learning model; generate a first output of the autoencoder machine learning model based on the first input; provide the first input to a production machine learning model; provide the first output of the autoencoder machine learning model as a second input to the production machine learning model; generate a first output of the production machine learning model based on the first input; generate a second output of the production machine learning model based on the second input; determine a metric of divergence between the first output of the production machine learning model and the second output of the production machine learning model, wherein the metric of divergence comprises an indication of whether the first input is associated with an adversarial attack; and perform an action based on the metric of divergence.

Further non-limiting embodiments or aspects are set forth in the following numbered clauses:

Clause 1: A system, comprising: at least one processor programmed or configured to: provide a first input to an autoencoder machine learning model; generate a first output of the autoencoder machine learning model based on the first input; provide the first input to a production machine learning model; provide the first output of the autoencoder machine learning model as a second input to the production machine learning model; generate a first output of the production machine learning model based on the first input; generate a second output of the production machine learning model based on the second input; determine a metric of divergence between the first output of the production machine learning model and the second output of the production machine learning model, wherein the metric of divergence comprises an indication of whether the first input is associated with an adversarial attack; and perform an action based on the metric of divergence.

Clause 2: The system of clause 1, wherein, when performing the action, the at least one processor is programmed or configured to: determine whether the metric of divergence satisfies a threshold value of divergence; and perform the action based on determining whether the metric of divergence satisfies the threshold value of divergence.

Clause 3: The system of clauses 1 or 2, wherein, when determining whether the metric of divergence satisfies the threshold value of divergence, the at least one processor is programmed or configured to: compare the metric of divergence to the threshold value of divergence; and wherein the threshold value of divergence is based on a number of times the production machine learning model correctly predicted an outcome.

Clause 4: The system of any of clauses 1-3, wherein the at least one processor is further programmed or configured to: re-train the autoencoder machine learning model based on the metric of divergence.

Clause 5: The system of any of clauses 1-4, wherein the at least one processor is further programmed or configured to: receive raw data from a request for inference for the production machine learning model; and perform a feature engineering procedure on the raw data to produce the first input.

Clause 6: The system of any of clauses 1-5, wherein, when performing the action, the at least one processor is programmed or configured to: determine whether the metric of divergence satisfies a threshold value of divergence; and provide the first output of the production machine learning model as a response to a request for inference for the production machine learning model based on determining that the metric of divergence does not satisfy the threshold value of divergence.

Clause 7: The system of any of clauses 1-6, wherein, when performing the action, the at least one processor is programmed or configured to: determine whether the metric of divergence satisfies a threshold value of divergence; and generate an alert based on determining that the metric of divergence does not satisfy the threshold value of divergence, or provide the first output of the production machine learning model as an input to an advanced production machine learning model based on determining that the metric of divergence satisfies the threshold value of divergence.

Clause 8: A computer-implemented method, comprising: providing, with at least one processor, a first input to an autoencoder machine learning model; generating, with at least one processor, a first output of the autoencoder machine learning model based on the first input; providing, with at least one processor, the first input to a production machine learning model; providing, with at least one processor, the first output of the autoencoder machine learning model as a second input to the production machine learning model; generating, with at least one processor, a first output of the production machine learning model based on the first input; generating, with at least one processor, a second output of the production machine learning model based on the second input; determining, with at least one processor, a metric of divergence between the first output of the production machine learning model and the second output of the production machine learning model, wherein the metric of divergence comprises an indication of whether the first input is associated with an adversarial attack; and performing, with at least one processor, an action based on the metric of divergence.

Clause 9: The computer-implemented method of clause 8, wherein performing the action comprises: determining whether the metric of divergence satisfies a threshold value of divergence; and performing the action based on determining whether the metric of divergence satisfies the threshold value of divergence.

Clause 10: The computer-implemented method of clauses 8 or 9, wherein determining whether the metric of divergence satisfies the threshold value of divergence comprises: comparing the metric of divergence to the threshold value of divergence; and wherein the threshold value of divergence is based on a number of times the production machine learning model correctly predicted an outcome.

Clause 11: The computer-implemented method of any of clauses 8-10, further comprising: re-training the autoencoder machine learning model based on the metric of divergence.

Clause 12: The computer-implemented method of any of clauses 8-11, further comprising: receiving raw data from a request for inference for the production machine learning model; and performing a feature engineering procedure on the raw data to produce the first input.

Clause 13: The computer-implemented method of any of clauses 8-12, wherein performing the action comprises: determining whether the metric of divergence satisfies a threshold value of divergence; and providing the first output of the production machine learning model as a response to a request for inference for the production machine learning model based on determining that the metric of divergence does not satisfy the threshold value of divergence.

Clause 14: The computer-implemented method of any of clauses 8-13, wherein performing the action comprises: determining whether the metric of divergence satisfies a threshold value of divergence; and generating an alert based on determining that the metric of divergence does not satisfy the threshold value of divergence, or providing the first output of the production machine learning model as an input to an advanced production machine learning model based on determining that the metric of divergence satisfies the threshold value of divergence.

Clause 15: A computer program product comprising at least one non-transitory computer-readable medium including one or more instructions that, when executed by at least one processor, cause the at least one processor to: provide a first input to an autoencoder machine learning model; generate a first output of the autoencoder machine learning model based on the first input; provide the first input to a production machine learning model; provide the first output of the autoencoder machine learning model as a second input to the production machine learning model; generate a first output of the production machine learning model based on the first input; generate a second output of the production machine learning model based on the second input; determine a metric of divergence between the first output of the production machine learning model and the second output of the production machine learning model, wherein the metric of divergence comprises an indication of whether the first input is associated with an adversarial attack; and perform an action based on the metric of divergence.

Clause 16: The computer program product of clause 15, wherein, the one or more instructions that cause the at least one processor to perform the action, cause the at least one processor to: determine whether the metric of divergence satisfies a threshold value of divergence; and perform the action based on determining whether the metric of divergence satisfies the threshold value of divergence.

Clause 17: The computer program product of clauses 15 or 16, wherein, the one or more instructions that cause the at least one processor to determine whether the metric of divergence satisfies the threshold value of divergence, cause the at least one processor to: compare the metric of divergence to the threshold value of divergence; and wherein the threshold value of divergence is based on a number of times the production machine learning model correctly predicted an outcome.

Clause 18: The computer program product of any of clauses 15-17, wherein the one or more instructions further cause the at least one processor to: receive raw data from a request for inference for the production machine learning model; and perform a feature engineering procedure on the raw data to produce the first input.

Clause 19: The computer program product of any of clauses 15-18, wherein, the one or more instructions that cause the at least one processor to perform the action, cause the at least one processor to: determine whether the metric of divergence satisfies a threshold value of divergence; and provide the first output of the production machine learning model as a response to a request for inference for the production machine learning model based on determining that the metric of divergence does not satisfy the threshold value of divergence.

Clause 20: The computer program product of any of clauses 15-19, wherein, the one or more instructions that cause the at least one processor to perform the action, cause the at least one processor to: determine whether the metric of divergence satisfies a threshold value of divergence; and generate an alert based on determining that the metric of divergence does not satisfy the threshold value of divergence, or provide the first output of the production machine learning model as an input to an advanced production machine learning model based on determining that the metric of divergence satisfies the threshold value of divergence.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for detecting an adversarial attack using a machine learning framework; and

FIGS. 4A-4F are diagrams of non-limiting embodiments or aspects of an implementation of a process for detecting an anomaly in a multivariate time series.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Non-limiting embodiments or aspects of the present disclosure are directed to systems, methods, and computer program products for detecting an adversarial attack using a machine learning framework. In some non-limiting embodiments or aspects, an adversarial detection system may provide a first input to an autoencoder machine learning model; generate a first output of the autoencoder machine learning model based on the first input; provide the first input to a production machine learning model; provide the first output of the autoencoder machine learning model as a second input to the production machine learning model; generate a first output of the production machine learning model based on the first input; generate a second output of the production machine learning model based on the second input; determine a metric of divergence between the first output of the production machine learning model and the second output of the production machine learning model, wherein the metric of divergence comprises an indication of whether the first input is associated with an adversarial attack; and perform an action based on the metric of divergence.

In some non-limiting embodiments or aspects, when performing the action, the adversarial detection system may determine whether the metric of divergence satisfies a threshold value of divergence and perform the action based on determining whether the metric of divergence satisfies the threshold value of divergence. In some non-limiting embodiments or aspects, when determining whether the metric of divergence satisfies the threshold value of divergence, the adversarial detection system may compare the metric of divergence to the threshold value of divergence. In some non-limiting embodiments or aspects, the threshold value of divergence may be based on a number of times the production machine learning model correctly predicted an outcome. In some non-limiting embodiments or aspects, the adversarial detection system may re-train the autoencoder machine learning model based on the metric of divergence. In some non-limiting embodiments or aspects, the adversarial detection system may receive raw data from a request for inference for the production machine learning model and perform a feature engineering procedure on the raw data to produce the first input.

In some non-limiting embodiments or aspects, when performing the action, the adversarial detection system may determine whether the metric of divergence satisfies a threshold value of divergence and provide the first output of the production machine learning model as a response to a request for inference for the production machine learning model based on determining that the metric of divergence satisfies the threshold value of divergence.

In some non-limiting embodiments or aspects, when performing the action, the adversarial detection system may determine whether the metric of divergence satisfies a threshold value of divergence, and generate an alert based on determining that the metric of divergence satisfies the threshold value of divergence or provide the first output of the production machine learning model as an input to an advanced production machine learning model based on determining that the metric of divergence satisfies the threshold value of divergence.

In this way, the adversarial detection system may provide for accurately analyzing raw data to determine whether the raw data include an adversarial attack, in the form of injected adversarial examples. Non-limiting embodiments or aspects may provide for the ability to accurately detect adversarial attacks without a need to reserve additional computational resources and store samples of adversarial and/or non-adversarial examples to determine whether an input is an adversarial example. Furthermore, non-limiting embodiments or aspects may provide for improved detection of adversarial events (e.g., adversarial examples injected by an attacker) by using an autoencoder based machine learning model.

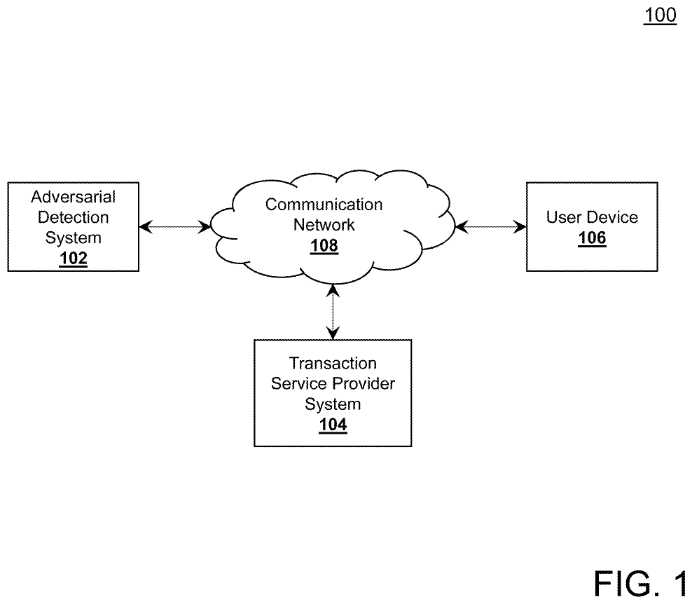

Referring now to FIG. 1, FIG. 1 is a diagram of an example environment 100 in which devices, systems, and/or methods, described herein, may be implemented. As shown in FIG. 1, environment 100 may include adversarial detection system 102, transaction service provider system 104, user device 106, and communication network 108. Adversarial detection system 102, transaction service provider system 104, and/or user device 106 may interconnect (e.g., establish a connection to communicate) via wired connections, wireless connections, or a combination of wired and wireless connections.

Adversarial detection system 102 may include one or more devices configured to communicate with transaction service provider system 104 and/or user device 106 via communication network 108. For example, adversarial detection system 102 may include a server, a group of servers, and/or other like devices. In some non-limiting embodiments or aspects, adversarial detection system 102 may be associated with a transaction service provider system (e.g., may be operated by a transaction service provider as a component of a transaction service provider system, may be operated by a transaction service provider independent of a transaction service provider system, etc.), as described herein. Additionally or alternatively, adversarial detection system 102 may generate (e.g., train, validate, re-train, and/or the like), store, and/or implement (e.g., operate, provide inputs to and/or outputs from, and/or the like) one or more machine learning models. For example, adversarial detection system 102 may generate one or more machine learning models by fitting (e.g., validating) one or more machine learning models against data used for training (e.g., training data). In some non-limiting embodiments or aspects, adversarial detection system 102 may generate, store, and/or implement one or more autoencoder machine learning models and/or one or more machine learning models that are provided for a production environment (e.g., a real-time or runtime environment used for providing inferences based on data in a live situation). In some non-limiting embodiments or aspects, adversarial detection system 102 may be in communication with a data storage device, which may be local or remote to adversarial detection system 102. In some non-limiting embodiments or aspects, adversarial detection system 102 may be capable of receiving information from, storing information in, transmitting information to, and/or searching information stored in the data storage device.

Transaction service provider system 104 may include one or more devices configured to communicate with adversarial detection system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider system, as discussed herein. In some non-limiting embodiments or aspects, time series analysis system may be a component of transaction service provider system 104.

User device 106 may include a computing device configured to communicate with adversarial detection system 102 and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

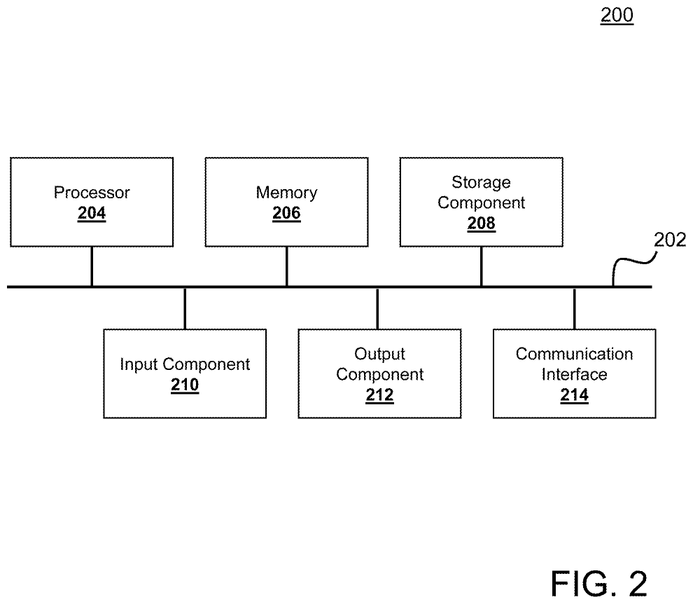

Referring now to FIG. 2, FIG. 2 is a diagram of example components of a device 200. Device 200 may correspond to adversarial detection system 102 (e.g., one or more devices of adversarial detection system 102), transaction service provider system 104 (e.g., one or more devices of transaction service provider system 104), and/or user device 106. In some non-limiting embodiments or aspects, adversarial detection system 102, transaction service provider system 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

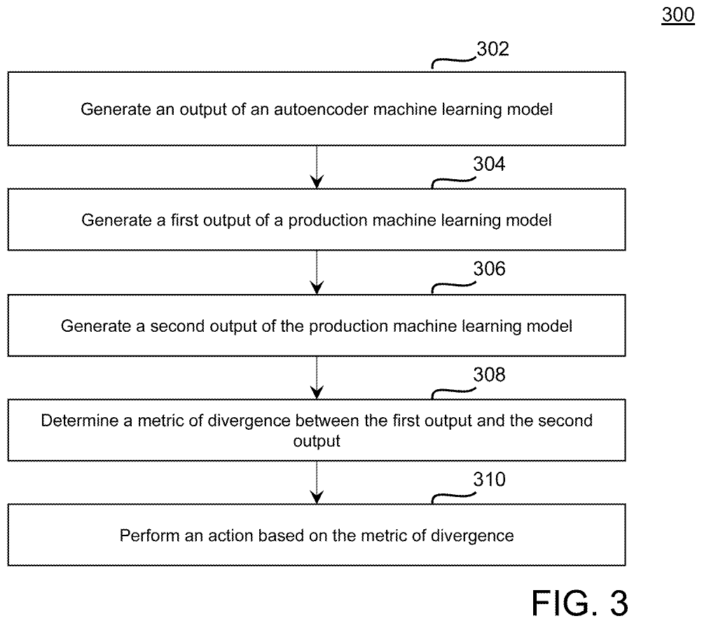

Referring now to FIG. 3, FIG. 3 is a flowchart of a non-limiting embodiment or aspect of a process 300 for detecting an adversarial attack using a machine learning framework. In some non-limiting embodiments or aspects, one or more of the steps of process 300 may be performed (e.g., completely, partially, etc.) by adversarial detection system 102 (e.g., one or more devices of adversarial detection system 102). In some non-limiting embodiments or aspects, one or more of the steps of process 300 may be performed (e.g., completely, partially, etc.) by another device or a group of devices separate from or including adversarial detection system 102 (e.g., one or more devices of adversarial detection system 102), transaction service provider system 104 (e.g., one or more devices of transaction service provider system 104), and/or user device 106.

As shown in FIG. 3, at step 302, process 300 includes generating an output of an autoencoder machine learning model. For example, adversarial detection system 102 may generate an output of an autoencoder machine learning model. In some non-limiting embodiments or aspects, adversarial detection system 102 may provide a first input to an autoencoder machine learning model and generate a first output of the autoencoder machine learning model based on the first input.

In some non-limiting embodiments or aspects, adversarial detection system 102 may receive raw data associated with (e.g., including in) a request for inference for a production machine learning model and perform a feature engineering procedure on the raw data to produce the first input. In some non-limiting embodiments or aspects, the raw data may be associated with a task for which the production machine learning model may provide an inference. In some non-limiting embodiments or aspects, the raw data may be associated with financial service tasks. For example, the raw data may be associated with a token service task, an authentication task (e.g., a 3D secure authentication task), a fraud detection task, and/or the like.

In some non-limiting embodiments or aspects, the raw data may include runtime input data. In some non-limiting embodiments or aspects, the runtime input data may include a sample of data that is received by a trained machine learning model in real-time with respect to the runtime input data being generated. In some non-limiting embodiments or aspects, real-time may refer to a time at which, or close to a time at which, operations of a system, such as adversarial detection system 102 are carried out. For example, runtime input data may be generated by a data source (e.g., a customer performing a transaction) and may be subsequently received by the trained machine learning model in real-time. Runtime (e.g., production) may refer to inputting runtime data (e.g., a runtime dataset, real-world data, real-world observations, and/or the like) into one or more trained machine learning models (e.g., one or more trained machine learning models of adversarial detection system 102) and/or generating an inference (e.g., generating an inference using adversarial detection system 102 or another machine learning system).

In some non-limiting embodiments or aspects, runtime may be performed during a phase which may occur after a training phase, after a testing phase, and/or after deployment of the machine learning model into a production environment. During a time period associated with the runtime phase, the machine learning model (e.g., a production machine learning model) may process the runtime input data to generate inferences (e.g., real-time inferences, real-time predictions, and/or the like).

In some non-limiting embodiments or aspects, an autoencoder machine learning model may include a specific type of feedforward neural network where an input to the feedforward neural network is the same as the output of the feedforward neural network. The feedforward neural network may be used to compress the input into a latent-space representation (e.g., a lower-dimensional code), which is a compact summary (e.g., a compression) of the input, and the output may be reconstructed from the latent-space representation. In some non-limiting embodiments or aspects, an autoencoder machine learning model may include three components: an encoder; a code; and a decoder. The encoder may be used to learn a projection method to map an input to a manifold (e.g., kernel space), which has a lower dimension than the input. The code may be used to compress the input and produce the latent-space representation, and the decoder may be used to reconstruct the input using the latent-space representation.

As shown in FIG. 3, at step 304, process 300 includes generating a first output of a production machine learning model. For example, adversarial detection system 102 may generate a first output of a production machine learning model. In some non-limiting embodiments or aspects, adversarial detection system 102 may generate the first output of the production machine learning model based on the first input that was provided as an input to an autoencoder machine learning model. For example, adversarial detection system 102 may provide a first input to the production machine learning model, and the first input is the same as the first input provided to the autoencoder machine learning model. Adversarial detection system 102 may generate the first output of the production machine learning model based on providing the first input (e.g., as an input) to the production machine learning model. In some non-limiting embodiments or aspects, adversarial detection system 102 may generate the first output of the production machine learning model based on the first input at the same time that adversarial detection system 102 generates a first output of the autoencoder machine learning model based on the first input.

In some non-limiting embodiments or aspects, a production machine learning model may include a machine learning model that has been trained and/or validated (e.g., tested) and that may be used to generate inferences (e.g., prediction), such as real-time inferences, runtime inferences, and/or the like. As shown in FIG. 3, at step 306, process 300 includes generating a second output of the production machine learning model. For example, adversarial detection system 102 may generate a second output of the production machine learning model.

In some non-limiting embodiments or aspects, adversarial detection system 102 may generate the second output of the production machine learning model based on an output of an autoencoder machine learning model. For example, adversarial detection system 102 may provide a first input to the autoencoder machine learning model, and the second output of the production machine learning model is based on an output of the autoencoder machine learning model that resulted from the first input (e.g., the first input that was used to generate the first output of the production machine learning model). Adversarial detection system 102 may generate the second output of the production machine learning model based on providing the output of the autoencoder machine learning model (e.g., as an input) to the production machine learning model. In some non-limiting embodiments or aspects, adversarial detection system 102 may generate the second output of the production machine learning model based on the output of the autoencoder machine learning model at the same time that adversarial detection system 102 generates an output of the autoencoder machine learning model based on the first input.

As shown in FIG. 3, at step 308, process 300 includes determining a metric of divergence between the first output and the second output. For example, adversarial detection system 102 may determine a metric of divergence between the first output and the second output of the production machine learning model. The metric of divergence may include an indication of whether an input (e.g., a first input to a production machine learning model) is associated with an adversarial attack. In some non-limiting embodiments or aspects, the metric of divergence may include a value of the Kullback-Leibler (KL) divergence (e.g., relative entropy, I-divergence, etc.). In some non-limiting embodiments or aspects, KL divergence is a type of statistical distance that provides a measure of how a first probability distribution is different from a second, reference probability distribution.

In some non-limiting embodiments or aspects, adversarial detection system 102 may train (e.g., re-train) a trained machine learning model, such as an autoencoder machine learning model and/or a production machine learning model, based on the metric of divergence. For example, adversarial detection system 102 may re-train the trained machine learning model based on the value of the KL divergence between the first output and the second output of the production machine learning model.

As shown in FIG. 3, at step 310, process 300 includes performing an action based on the metric of divergence. For example, adversarial detection system 102 may perform an action based on the metric of divergence. In some non-limiting embodiments or aspects, adversarial detection system 102 may determine whether the metric of divergence satisfies a threshold value of divergence and performs the action based on determining whether the metric of divergence satisfies the threshold value of divergence. For example, adversarial detection system 102 may determine the metric of divergence between the first output and the second output of the production machine learning model and may compare the metric of divergence to the threshold value of divergence. If the metric of divergence satisfies the threshold value of divergence, adversarial detection system 102 may perform the action based on determining that the metric of divergence satisfies the threshold value of divergence. If the metric of divergence does not satisfy the threshold value of divergence, adversarial detection system 102 may forego performing the action based on determining that the metric of divergence does not satisfy the threshold value of divergence. In some non-limiting embodiments or aspects, the threshold value of divergence is a value that is based on a number of times the production machine learning model correctly predicted an outcome. In some non-limiting embodiments or aspects, the threshold value of divergence is a value that may be updated. For example, adversarial detection system 102 may update the threshold value of divergence based on the number of times the production machine learning model correctly predicted an outcome. In some non-limiting embodiments or aspects, if the production machine learning model correctly predicted an outcome for a number of predetermined inferences, adversarial detection system 102 may forego updating the threshold value of divergence. In some non-limiting embodiments or aspects, if the production machine learning model does not correctly predict an outcome for the number of predetermined inferences, adversarial detection system 102 may update the threshold value of divergence.

In some non-limiting embodiments or aspects, adversarial detection system 102 may perform the action by providing the first output of the production machine learning model as a response to a request for inference for the production machine learning model. In some non-limiting embodiments or aspects, adversarial detection system 102 may perform the action by generating and transmitting an alert (e.g., an alert message) based on determining that the metric of divergence does not satisfy the threshold value of divergence. For example, adversarial detection system 102 may perform the action by generating and transmitting an alert to user device 106 (e.g., a user associated with user device 106, such as a subject matter expert). Additionally or alternatively, adversarial detection system 102 may perform the action by providing the first output of the production machine learning model as an input to an advanced production machine learning model. The advanced production machine learning model may include a machine learning model that is configured to perform the same or similar task as the production machine learning model, however, the advanced production machine learning model may be more accurate, may require more time, and/or may require additional computational resources, as compared to the production machine learning model, in order to carry out the task.

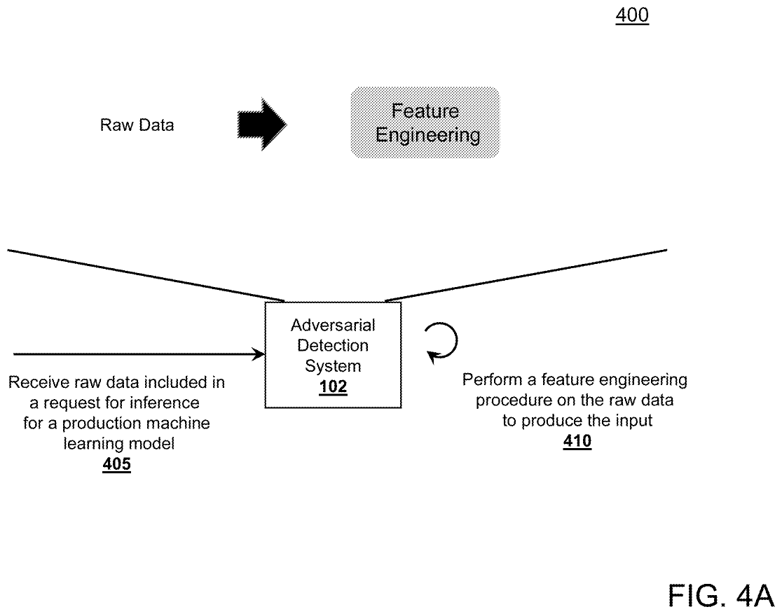

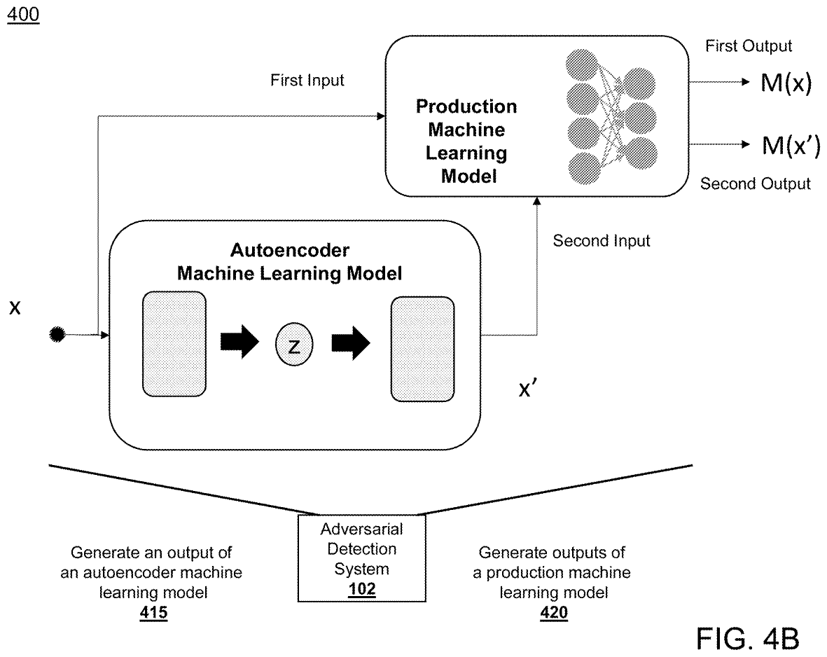

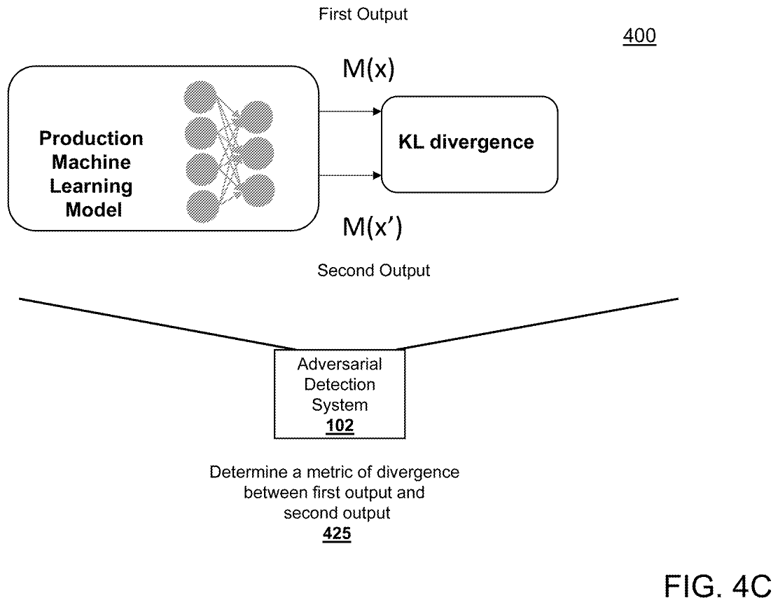

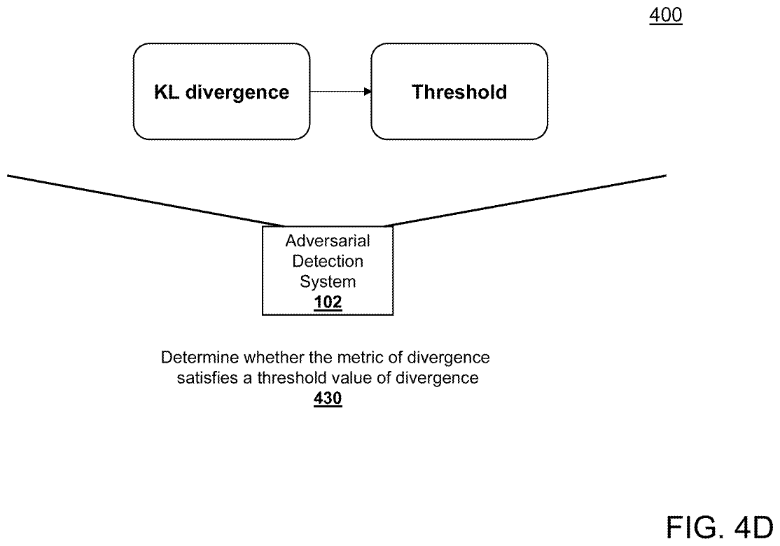

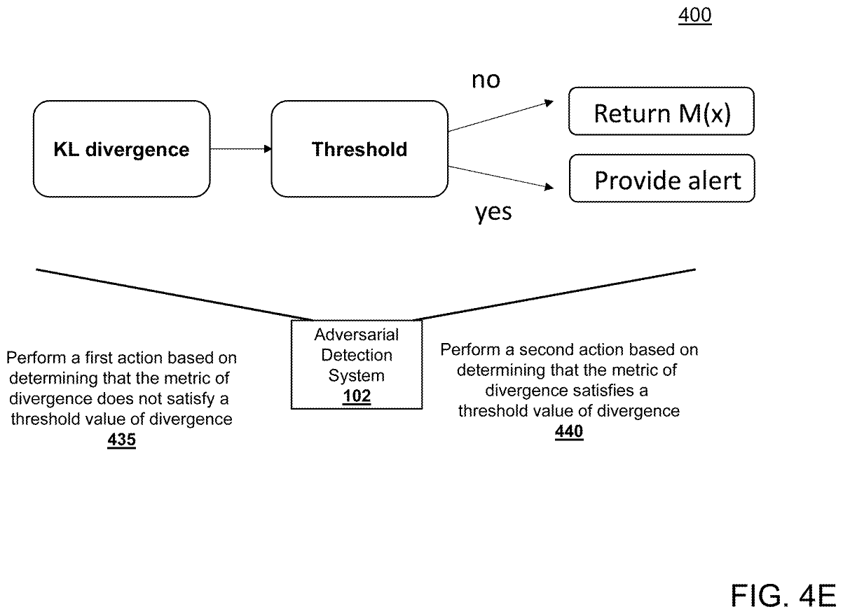

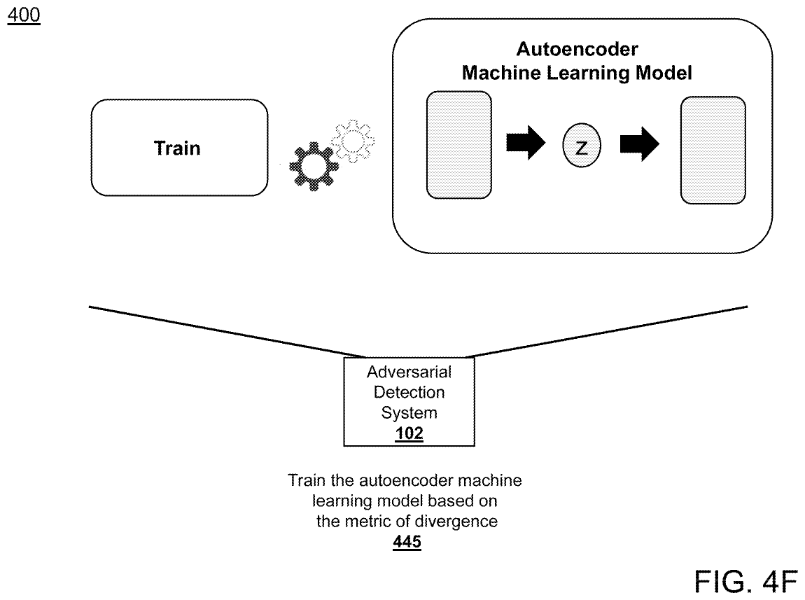

Referring now to FIGS. 4A-4F, FIGS. 4A-4F are diagrams of non-limiting embodiments or aspects of an implementation 400 of a process (e.g., process 300) for detecting an adversarial attack using a machine learning framework.

As shown by reference number 405 in FIG. 4A, adversarial detection system 102 may receive raw data that is included in a request for inference for a production machine learning model. For example, adversarial detection system 102 may receive the request for inference for the production machine learning model in real-time, and the request for inference may be associated with a financial service provided by a transaction service provider. As further shown by reference number 410 in FIG. 4A, adversarial detection system 102 may perform a feature engineering procedure on the raw data to produce a first input. Adversarial detection system 102 may perform the feature engineering procedure on the raw data to provide the first input in a format that is appropriate for the production machine learning model. In some non-limiting embodiments or aspects, the first input may be an input that is to be provided to the production machine learning model as an input that may be used to provide an inference in real-time.

As shown by reference number 415 in FIG. 4B, adversarial detection system 102 may generate a first output, shown as “x”, of an autoencoder machine learning model. For example, adversarial detection system 102 may provide the first input, shown as “x”, to the autoencoder machine learning model and may generate the first output of the autoencoder machine learning model based on the first input. As further shown by reference number 420 in FIG. 4B, adversarial detection system 102 may generate outputs of a production machine learning model. For example, adversarial detection system 102 may provide the first input to the production machine learning model and may provide the first output of the autoencoder machine learning model as a second input to the production machine learning model. Adversarial detection system 102 may generate a first output, shown as “M (x)”, of the production machine learning model based on the first input and may generate a second output, shown as “M (x′)”, of the production machine learning model based on the second input.

As shown by reference number 425 in FIG. 4C, adversarial detection system 102 may determine a metric of divergence between the first output of the production machine learning model and the second output of the production machine learning model. In some non-limiting embodiments or aspects, the metric of divergence comprises an indication of whether the first input is associated with an adversarial attack. In some non-limiting embodiments or aspects, the metric of divergence may include a value of the KL divergence between the first output and the second output of the production machine learning model.

As shown by reference number 430 in FIG. 4D, adversarial detection system 102 may determine whether the metric of divergence satisfies a threshold value of divergence. For example, adversarial detection system 102 may compare the metric of divergence to the threshold value of divergence based on determining the metric of divergence. In some non-limiting embodiments or aspects, the threshold value of divergence is based on a number of times the production machine learning model correctly predicted an outcome.

As shown by reference number 435 in FIG. 4E, adversarial detection system 102 may perform a first action based on determining that the metric of divergence does not satisfy a threshold value of divergence. For example, adversarial detection system 102 may provide the first output of the production machine learning model as a response to the request for inference for the production machine learning model based on determining that the metric of divergence does not satisfy the threshold value of divergence. As further shown by reference number 440 in FIG. 4E, adversarial detection system 102 may perform a second action based on determining that the metric of divergence satisfies a threshold value of divergence. For example, adversarial detection system 102 may generate an alert based on determining that the metric of divergence does not satisfy the threshold value of divergence and/or provide the first output of the production machine learning model as an input to an advanced production machine learning model based on determining that the metric of divergence satisfies the threshold value of divergence.

As shown by reference number 445 in FIG. 4F, adversarial detection system 102 may train the autoencoder machine learning model based on the metric of divergence. For example, adversarial detection system 102 may re-train the autoencoder machine learning model (e.g., the trained autoencoder machine learning model) according to the formula:

$$K L ( P ‖ Q ) = {\sum }_{x ∈ χ} log \frac{P ( x )}{Q ( x )}$$

where KL (P∥Q) is the KL divergence of the second output, P, of the production machine learning model from the first output, Q, of the production machine learning model, which may be used as a reference.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A system, comprising:
at least one processor programmed or configured to:
provide a first input to an autoencoder machine learning model;
generate a first output of the autoencoder machine learning model based on the first input;
provide the first input to a production machine learning model;
provide the first output of the autoencoder machine learning model as a second input to the production machine learning model;
generate a first output of the production machine learning model based on the first input;
generate a second output of the production machine learning model based on the second input;
determine a metric of divergence between the first output of the production machine learning model and the second output of the production machine learning model, wherein the metric of divergence comprises an indication of whether the first input is associated with an adversarial attack; and
perform an action based on the metric of divergence.

2. The system of claim 1, wherein, when performing the action, the at least one processor is programmed or configured to:
determine whether the metric of divergence satisfies a threshold value of divergence; and
perform the action based on determining whether the metric of divergence satisfies the threshold value of divergence.

3. The system of claim 2, wherein, when determining whether the metric of divergence satisfies the threshold value of divergence, the at least one processor is programmed or configured to:
compare the metric of divergence to the threshold value of divergence; and
wherein the threshold value of divergence is based on a number of times the production machine learning model correctly predicted an outcome.

4. The system of claim 1, wherein the at least one processor is further programmed or configured to:
re-train the autoencoder machine learning model based on the metric of divergence.

5. The system of claim 1, wherein the at least one processor is further programmed or configured to:
receive raw data from a request for inference for the production machine learning model; and
perform a feature engineering procedure on the raw data to produce the first input.

6. The system of claim 1, wherein, when performing the action, the at least one processor is programmed or configured to:
determine whether the metric of divergence satisfies a threshold value of divergence; and
provide the first output of the production machine learning model as a response to a request for inference for the production machine learning model based on determining that the metric of divergence does not satisfy the threshold value of divergence.

7. The system of claim 1, wherein, when performing the action, the at least one processor is programmed or configured to:
determine whether the metric of divergence satisfies a threshold value of divergence; and
generate an alert based on determining that the metric of divergence does not satisfy the threshold value of divergence, or
provide the first output of the production machine learning model as an input to an advanced production machine learning model based on determining that the metric of divergence satisfies the threshold value of divergence.

8. A computer-implemented method, comprising:
providing, with at least one processor, a first input to an autoencoder machine learning model;
generating, with at least one processor, a first output of the autoencoder machine learning model based on the first input;
providing, with at least one processor, the first input to a production machine learning model;
providing, with at least one processor, the first output of the autoencoder machine learning model as a second input to the production machine learning model;
generating, with at least one processor, a first output of the production machine learning model based on the first input;
generating, with at least one processor, a second output of the production machine learning model based on the second input;
determining, with at least one processor, a metric of divergence between the first output of the production machine learning model and the second output of the production machine learning model, wherein the metric of divergence comprises an indication of whether the first input is associated with an adversarial attack; and
performing, with at least one processor, an action based on the metric of divergence.

9. The computer-implemented method of claim 8, wherein performing the action comprises:
determining whether the metric of divergence satisfies a threshold value of divergence; and
performing the action based on determining whether the metric of divergence satisfies the threshold value of divergence.

10. The computer-implemented method of claim 9, wherein determining whether the metric of divergence satisfies the threshold value of divergence comprises:
comparing the metric of divergence to the threshold value of divergence; and
wherein the threshold value of divergence is based on a number of times the production machine learning model correctly predicted an outcome.

11. The computer-implemented method of claim 8, further comprising:
re-training the autoencoder machine learning model based on the metric of divergence.

12. The computer-implemented method of claim 8, further comprising:
receiving raw data from a request for inference for the production machine learning model; and
performing a feature engineering procedure on the raw data to produce the first input.

13. The computer-implemented method of claim 8, wherein performing the action comprises:
determining whether the metric of divergence satisfies a threshold value of divergence; and
providing the first output of the production machine learning model as a response to a request for inference for the production machine learning model based on determining that the metric of divergence does not satisfy the threshold value of divergence.

14. The computer-implemented method of claim 8, wherein performing the action comprises:
determining whether the metric of divergence satisfies a threshold value of divergence; and
generating an alert based on determining that the metric of divergence does not satisfy the threshold value of divergence, or
providing the first output of the production machine learning model as an input to an advanced production machine learning model based on determining that the metric of divergence satisfies the threshold value of divergence.

15. A computer program product comprising at least one non-transitory computer-readable medium including one or more instructions that, when executed by at least one processor, cause the at least one processor to:
provide a first input to an autoencoder machine learning model;
generate a first output of the autoencoder machine learning model based on the first input;
provide the first input to a production machine learning model;
provide the first output of the autoencoder machine learning model as a second input to the production machine learning model;
generate a first output of the production machine learning model based on the first input;
generate a second output of the production machine learning model based on the second input;
determine a metric of divergence between the first output of the production machine learning model and the second output of the production machine learning model, wherein the metric of divergence comprises an indication of whether the first input is associated with an adversarial attack; and
perform an action based on the metric of divergence.

16. The computer program product of claim 15, wherein, the one or more instructions that cause the at least one processor to perform the action, cause the at least one processor to:
determine whether the metric of divergence satisfies a threshold value of divergence; and
perform the action based on determining whether the metric of divergence satisfies the threshold value of divergence.

17. The computer program product of claim 16, wherein, the one or more instructions that cause the at least one processor to determine whether the metric of divergence satisfies the threshold value of divergence, cause the at least one processor to:
compare the metric of divergence to the threshold value of divergence; and
wherein the threshold value of divergence is based on a number of times the production machine learning model correctly predicted an outcome.

18. The computer program product of claim 15, wherein the one or more instructions further cause the at least one processor to:
receive raw data from a request for inference for the production machine learning model; and
perform a feature engineering procedure on the raw data to produce the first input.

19. The computer program product of claim 15, wherein, the one or more instructions that cause the at least one processor to perform the action, cause the at least one processor to:
determine whether the metric of divergence satisfies a threshold value of divergence; and
provide the first output of the production machine learning model as a response to a request for inference for the production machine learning model based on determining that the metric of divergence does not satisfy the threshold value of divergence.

20. The computer program product of claim 15, wherein, the one or more instructions that cause the at least one processor to perform the action, cause the at least one processor to:
determine whether the metric of divergence satisfies a threshold value of divergence; and
generate an alert based on determining that the metric of divergence does not satisfy the threshold value of divergence, or
provide the first output of the production machine learning model as an input to an advanced production machine learning model based on determining that the metric of divergence satisfies the threshold value of divergence.
